(19) United States
(12) Patent Application Publication
(10) Pub. No.: US 2005/0056377 A1
(43) Pub. Date: Mar. 17, 2005

(54) Transfer tool

(75) Inventor: Mitsuhiro Tominaga, Osaka (JP)

Correspondence Address: BRINKS HOFER GILSON & LIONE;SUITE 3600, NBC TOWER, P.O. BOX 10395, CHICAGO, IL, 60610, US

(73) Assignee: General Co., Ltd.

(21) Appl. No.: 10/792,343

(22) Filed: Mar. 3, 2004

(30) Foreign Application Priority Data
Sep. 17, 2003 (JP) JP2003-324738

(51) Int. Cl. B44C 1/00; B44C 7/00

(52) U.S. Cl. 156/540; 156/577; 156/574

(57) ABSTRACT

A transfer tool having a housing, a supply reel around which a long ribbon substrate coated with a coating film is wound, and a take-up reel receiving the substrate after transferring the coating film to a targeted object, and is designed so that the inner face of the housing is roughened at least in a region where the coating film on the substrate may contact it.

### RELATED APPLICATIONS

The present patent document claims the benefit of the foreign filing date under 35 U.S.C. §1 19(a) of Japanese Patent Application Serial No. JP2003-324738 filed Sep. 17, 2003, which is hereby incorporated by reference.

### BACKGROUND OF THE INVENTION

The present invention relates to a transfer tool that is designed to prevent coating film from sticking to the inner walls of the transfer tool housing even when a substrate coated with the coating film develops slack. The coating film is applied and stored on a ribbon-like substrate. The substrate is fed to a dispenser from a supply shaft and once the coating film is dispensed, the substrate is received, wrapped and stored on a take-up shaft. Preventing the coating film from sticking to the inner walls of the housing ensures a smooth feed and take-up motion of the ribbon or tape as it travels through the housing of the transfer tool. Such a transfer tool is inexpensive and simple to fabricate. Further, the term “release” as referred to herein is meant to indicate a motion of “release of coating”.

Recently, a transfer tool for transferring a layer of coating film to an object to receive a transfer, such as paper, has become popular, replacing, for example, liquid whiteout or liquid adhesive, as it is easy to use and a desired amount of the coating film can be transferred from it. A transfer tool of one type applies a whiteout correction film over typing errors to correct them. A transfer tool of another type applies an adhesive film over targeted objects that require an adhesive.

Except that one applies a whiteout correction film and the other applies an adhesive film, the above two transfer tools comprise the following common structural members: there is a housing in which a supply shaft, a take-up shaft and a dispenser are provided. The supply shaft rotates to feed a ribbon-like substrate coated with a layer of coating film. The take-up shaft also rotates to take up the ribbon-like substrate after the coating film is applied to an object.

The take-up shaft and the supply shaft are geared to each other, and while the supply shaft rotates to feed the substrate, the take-up shaft also rotates along with the rotation of the supply shaft. The dispenser protrudes out from an opening formed at one end of the housing. At the dispenser, the coating film-coated substrate that has been fed from the supply shaft is pressed onto a target object. The coating film is then transferred to it. The substrate is thereafter taken up by the take-up shaft.

In existing transfer tools, the coating film, such as an adhesive film discussed above, coated on the substrate, may come in contact with the inner walls of the housing (except those parts wound around the shafts). If the substrate is improperly fed or taken up, it will develop slack and, as a result, the coating film may be brought into contact with the inner walls of the housing and will stick to it. If that occurs the substrate will not be properly fed or taken up.

This problem may occur on both upstream and downstream sides of the dispenser not only on the upstream the side where the coating film-coated substrate is supplied, but also on the downstream side where the substrate that has already been used for correction is taken up. This is because some of the coating film remains on the substrate and will stick to the inner walls of the housing. In addition, the problem happens more often in current small-sized transfer tools, since the distance between the traveling substrate and the inner walls of the housing is small. One way to solve the above problem has been recognized in the following patent, JP-A 7-267478, (Patent Reference 1).

Patent reference 1 discloses a technique in which the inner surfaces of an opening of housing from which a presser protrudes out are coated with a layer of a non-adhesive material such as silicon resin or fluororesin. In this structure, the coating film may be prevented from sticking to the inner surfaces of the opening of the housing from which the presser protrudes out, even when it brought in contact with the surfaces.

In the above-mentioned patent reference 1, however, since the coating layer is formed only on the inner surfaces of the opening of the container body from which the presser protrudes out, it cannot prevent the coating film from sticking to the inner walls of the housing.

Specifically, the presser and the other parts from which the presser protrudes are peculiar to the tool disclosed in patent reference 1. On the other hand, in transfer tools, when the coated substrate develops slack, then the coating film may stick to the inner walls of the housing along the route where the substrate travels inside the housing after it has been fed and before it is taken up. Patent reference 1 does not address those areas of travel. In addition, the coating layer formed in patent reference 1 has another problem. Additional production steps are necessary to form the coating layer, including the step of, for example, drying the layer to fix it. In short, when the number of the additional production steps increases so do the production costs therefore.

The problems that this invention solves are the following: When the coating film-coated substrate develops slack in a transfer tool, the coating film may stick to the inner walls of the housing of the tool. If the coating film sticks to the inner walls of the housing, the substrate can not be smoothly fed and taken up. The conventional solution for these problems is expensive and complicated.

### SUMMARY OF THE INVENTION

An important feature of the present invention is that the inner walls of the housing of a transfer tool are roughened at least in a region where the coating film on a substrate may be brought into contact with the inner walls of the housing.

In the present invention, the inner walls of the housing are roughened at least in a region where the coating film coated on a ribbon-like substrate may be brought into contact with the inner walls of the housing. Therefore, when the coating film on the substrate is brought into contact with the roughened face, it is prevented from sticking there since the contact areas between the coating film and the roughened face are small, and, as a result, the coating film-coated substrate may be smoothly fed to the dispenser and taken up. In addition, the housing of the transfer tool is so designed that the inner walls of the housing are roughened. Therefore, the housing is inexpensive to manufacture and can be manufactured in a simple process, unlike the conventional transfer tools discussed above that require an additional number of necessary production steps.

Preferably, in the present invention, the center line average height, (Ra), of the projections of the roughened surface of the housing is made equal to or more than 5.0 μm. Also preferably, in the present invention, the ratio (p/h) of the pitch, (p), to the height, (h), of the projections, (is made equal to or less than 22.0). Further preferable in the present invention is that under the condition that the ratio (p/h) of the pitch, (p), to the height, (h), of the projections, is at most 22.0, if either or both of the options is taken, i.e., the tapered angle of the tip of each projection is made an angle of between 5° and 120° and/or the roughened surface contains a separation material, the effects and the advantages of the present invention become more significant.

### BRIEF DESCRIPTION OF THE DRAWINGS

FIG. 1 is a schematic view showing the outline of the transfer tool of the present invention.

FIG. 2 is a magnified view showing the roughened surface of the housing for the transfer tool.

FIG. 3A and FIG. 3B are views for explaining the center line average height (Ra) of the roughened surface.

FIG. 4A and FIG. 4B are views for explaining the load length ratio (tp) of the roughened surface.

FIG. 5A and FIG. 5B are views showing the tip angle of the projections of the roughened surface.

FIG. 6 is a view for explaining the height (h) and the pitch (p) of the projections of the roughened surface, and the ratio (p/h).

FIG. 7A and FIG. 7B are views showing the profile of the projections of the roughened surface.

### DESCRIPTION OF THE PREFERRED EMBODIMENTS

The transfer tool according to one preferred embodiment has a housing. In the housing there are provided a supply reel around which a long ribbon substrate coated with a layer of coating film is wound up, and a take-up reel that takes up the substrate after transferring the coating film to a targeted object. The supply and take-up reels are synchronously driven so that the take-up reel rotates along with the rotation of the supply reel. The transfer tool according to the present invention is characterized in that the inner walls of the housing are roughened at least in a region where the coating film on the substrate may be brought into contact with the walls.

The roughened surface may not be limited to a particular pattern. The projections and recesses may be formed in any pattern. For example, they may be formed in a creping pattern. They may be formed in grains, woven fabric, leather, or repetitions of predetermined pattern. Alternatively, they may be formed in a mat-finished pattern. Again, the projections and recesses may be formed in any other patterns or profiles.

In this embodiment, the roughened surface is provided in the inner face of the housing at least in a region where the coating film-coated substrate travels from the supply shaft to the dispenser, especially where the coating film faces the inner face of the housing. Needless-to-say, the roughened surface may occur across the inner surface where the ribbon travels between the dispenser to the take-up shaft. Roughening may be provided on the take-up side or upstream side of the dispenser, because not all of the coating film may have been transferred to the targeted object; it may have remained on the substrate. If the substrate contacts the inner wall even in this region, the product and the ribbon may stick to the inner walls of the tool. Thus, it may be desirable to roughen the entire inner wall of the housing.

Even when the coating film is brought into contact with the inner wall of the housing, the contact area between the coating film and the inner wall is reduced since the inner face is roughened. Therefore, the coating film is prevented from sticking to the inner wall of the housing. In other words, even when the coating film is kept in contact with the inner wall of the housing, it does not firmly stick and does not interfere with smooth traveling of the substrate from the supply reel to the take-up reel in the housing.

The roughened surface may be formed integrally with the housing when the housing is injection-molded. For example, the inner walls of the cavity of the mold are patterned to have a profile opposite to that to provide the intended roughened surface. A hot melt of thermoplastic resin is injected into the mold, cooled, and the housing is taken out of the mold. The housing is preferably made of a non-polar polyethylene or polypropylene, exhibiting good releasability, since the housing formed of it is easy to remove from the molding die and more effective to prevent a coating film from sticking to the surface.

In the embodiment, the inner face of the container body is roughened, not coated with a coating layer, to prevent the coating film from sticking to the surface. Therefore, the housing having such a roughened face may be integrally molded and thus produced in a simple process, thereby making the production cost inexpensive.

JIS B0601-1994 defines a center line average height. Preferably, the center line average height (Ra), as defined by JIS B0601-1994, of the projections of the roughened surface of the housing should be equal to or more than 5.0 μm. The reason why the center line average height, (Ra) is preferably at least 5.0 μm is as follows:

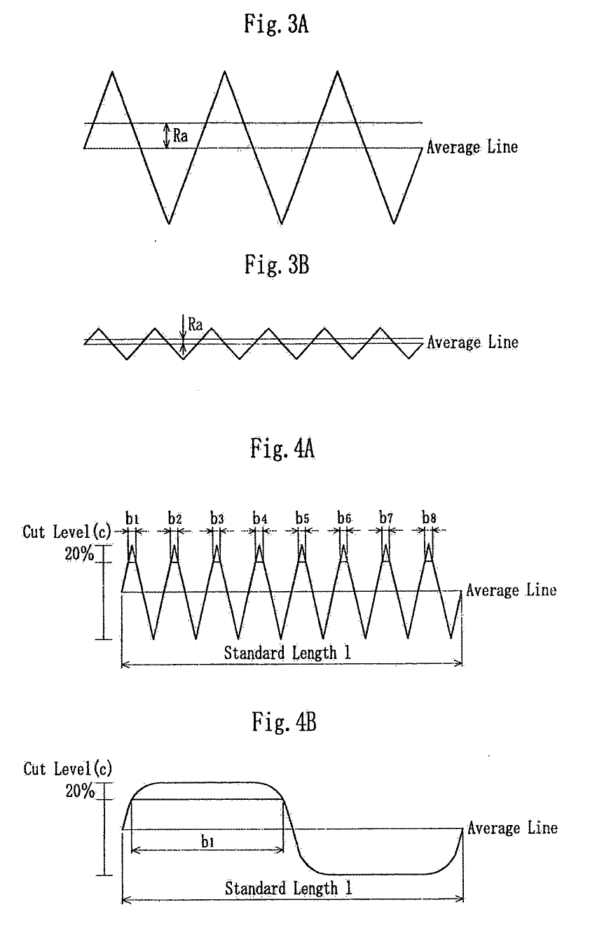

As illustrated in FIG. 3A, “a center line average height (Ra) has a large value” means that the average roughness of the roughened surface is large. When the height (Ra) is at least 5.0 μm, the coating film cannot reach the bottom of each recess of the roughened surface, and the total contact area of the coating film to the roughened surface is small. In contrast, “a center line average height (Ra) is small”, as illustrated in FIG. 3B, means that the average roughness of the roughened surface is small. If the height (Ra) is smaller than 5.0 μm, then the coating film may reach the bottom, or comes down nearly to the bottom, of each recess of the roughened surface, and the total contact area of the coating film to the roughened surface becomes large. Therefore, the coating film will stick to the surface and will therefore interfere with the travel of the substrate.

When the center line average height, (Ra) is made at least 5.0 μm, the coating film may be prevented from sticking to the roughened surface of the housing. More preferably, the center line average height, (Ra) is at least 7.0 μm, most preferably at least 9.0 μm to effectively prevent sticking of the coating film to the roughened surface. In addition to making the center line average height (Ra) as above larger than a certain value, it is further desirable that the load length ratio (tp) at a cut level (c) of 20%, as defined according to JIS B0601-1994, is made equal to or less than 20% because to do so will result in making more significant the above-mentioned effects and advantages of the invention.

When the center line average height (Ra) is made at least 5.0 μm, depending on the stiffness of the substrate, the depth that the coating film goes into the recesses of the roughened surface may be about 10% of the height of the projections. But even if it goes down to 20%, practically good results can still be obtained. Thus, the tips of the projections may be cut off at the 20% level in parallel to the average line. If the projections are so cut, the “cut level (c)” is defined as 20%. The ratio of the sum of the tip areas of the cut projections to a unit length is defined as a “load length ratio (tp)”.

When the cut level (c) is 20% and when the load length ratio tp=(b1+. . . bn/1)×100<20% as illustrated in FIG. 4A, the total contact area between the projections and the coating film will be small. The coating film will be prevented from sticking to the roughened surface.

However, when the cut level (c) is 20% and the load length ratio (tp) is larger than 20%, then the total contact area between the projections and the coating film becomes large, and the coating film may stick to the roughened surface. In an extreme case where the roughened surface has only one mountain as in FIG. 4B, obviously, tp=(b1/1)×100>20%, and the contact area between the mountain and the coating film increases. As a result, the coating film may stick to the mountain.

Therefore, it is preferable that the center line average height, (Ra) of the roughened surface is at least 5.0 μm and the load length ratio (tp) at a cut level (c) of 20% is at most 20%. The effects and the advantages of the present invention will be realized more significantly in this embodiment.

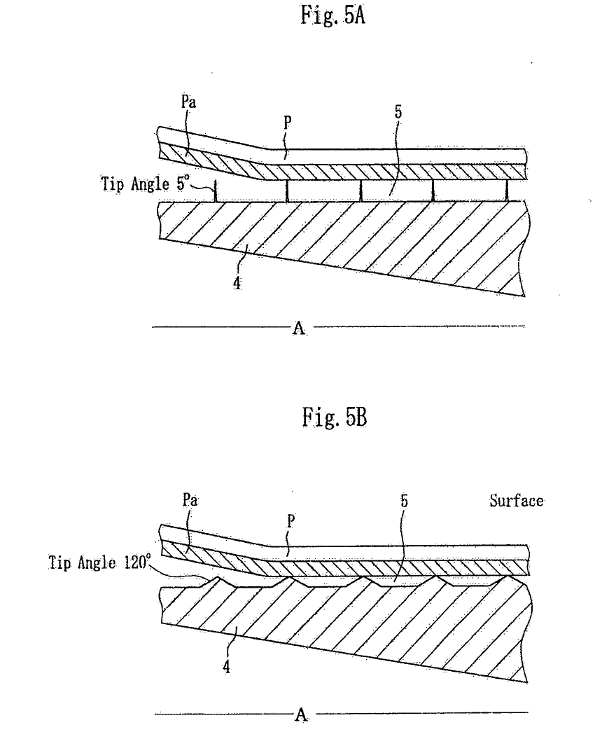

One way to define the present invention is, as discussed above, to focus on the overall contact area of the coating film to the inner walls of the housing. There is another way to define the present invention in view of how the coating film sticks to each projection of the roughened surface. In this regard, it has been found that the tip profile of the projections is preferably tapered at an angle of from 5 to 120°, as illustrated in FIG. 5.

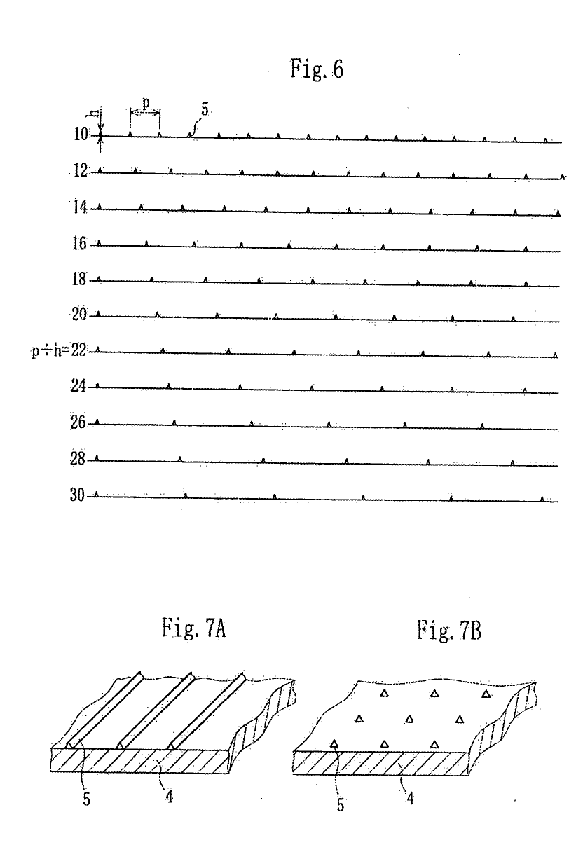

It should be noted that the profile of the projections of the roughened surface is not limited to a specific shape, for example, the projections may be gabled or triangular-conical, having a triangular cross section as shown in FIG. 7. There are reasons that the tips of the projections are preferably tapered at angles between 50 and 120°. If the tapered angle is smaller than 5°, the coating film may be damaged or broken when it contacts the roughened surface even though it may be prevented from sticking to the roughened surface. Additionally, if the tapered angle is smaller than 5°, a problem may arise in that the housing may not be easy to be removed from the molding die. On the other hand, if the tapered angle is greater than 120°, it is easy to remove the housing from the molding die. But the coating film may readily stick to the surface of the container since the contact area to the surface increases. Also, in another way to define the present invention, it is desirable that the ratio (p/h) of the pitch, (p), to the height, (h), of the projections is made equal to or less than 22.0 as illustrated in FIG. 6.

If the ratio of the pitch, (p), to the height, (h), of the projections, (p/h) is greater than 22.0, the coating film may stick to the roughened surface between the projections. If this occurs, the projections will no longer function as expected.

In addition, it is also desirable that at least the roughened surface of the container body of the transfer tool of the invention contain a non-stick material. Then, even if the coating film is brought into contact with the inner walls of the housing, it may be prevented from sticking.

Comparing the present invention to the technique in patent reference 1 patent reference 1 requires a silicon resin or fluororesin layer to be coated, whereas in the present invention, the non-stick material is a part of the material to be injection-molded to form the housing. In addition, since the housing according to this embodiment does not have a coating layer, the number of production steps for making it should be fewer than those necessary for the patent reference 1. Accordingly, the production rate of the transfer tool of the invention is high, and thus the production costs can be reduced.

The non-stick material may be, for example, magnesium stearate, zinc stearate, aluminum stearate and calcium stearate, and any of these may be added to the resin to form the housing.

The content ratio of the non-stick material in the resin is preferably from 0.3% to 0.8%. If the ratio is smaller than 0.3%, the non-stick material is ineffective for preventing the coating film from sticking to the inner walls of the housing. If larger than 0.8%, it is effective to prevent the coating film from sticking to the inner walls of the housing, but it may cause the screw of the molding machine to be too slippery for performing the intended injection molding operation.

Polar resins such as polystyrene or ABS are often used to form the housings of currently existing transfer tools, but those resins are defective because the coating film readily sticks to it. Therefore, in order to overcome this problem that the currently existing transfer tools have, the inner walls of the housing are roughened, and further, the roughness of the roughened face is specifically defined as discussed above. The present invention also proposes special compositions for the material to be used to form the housing in order to further the effect of the invention for preventing the coating film from sticking to the inner walls of the housing of the transfer tool.

### EXAMPLES

The invention and its effects are described in more detail with reference to the following examples.

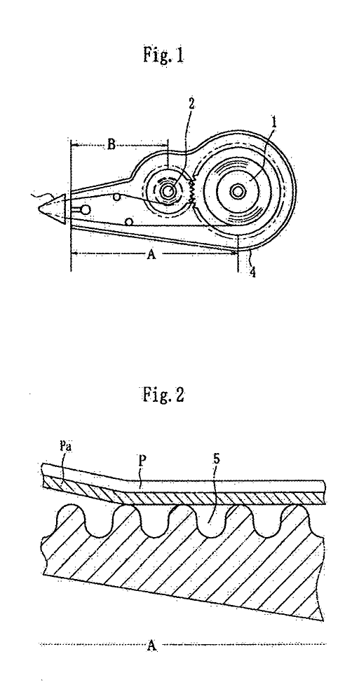

The transfer tool of the invention is constructed as shown in FIG. 1 and FIG. 2. 1 is a supply reel, and a long ribbon substrate P coated with a film Pa is wound around it. In these examples, the coating film Pa was an adhesive film. 2 is a take-up reel, and the substrate P that has released the coating film Pa onto a targeted object (not shown) is wound around it. 3 is a dispenser midway in the travel path of the substrate P between the supply reel 1 and the take-up reel 2. 4 is a housing that houses the supply reel 1 and the take-up reel 2 with the dispenser 3 partly protruding from it. 5 is a roughened surface of the inner wall of the housing 4, which is formed at least in a region where the coating film Pa may be brought into contact with the inner walls of the housing 4.

In the illustrated embodiment, for example, the roughened surface 5 of the inner wall of the housing 4 is formed in the path where the substrate P coated with the coating film Pa travels from the supply reel 1 to the dispenser 3 (path A), and the path where the substrate P that has just delivered the coating film Pa onto the targeted object travels from the dispenser 3 to the take-up reel 2 (path B), as shown in FIG. 1 and FIG. 2. Since the coating film Pa might not have been entirely transferred to the targeted object but partially remains on the substrate P, it could stick to the inner wall of the housing 4 if it came in contact with the inner wall. The roughened surface 5 may be formed only on the supply side (path A), or entirely in the inner walls of the housing 4. If the roughened surface 5 is desired to be minimized, it may be formed only along the path where the coating film Pa will face the inner walls of the housing.

The operation of the transfer tool follows: The take-up reel 2 is rotated in synchronization with the supply reel 1 where the ribbon-like substrate P coated with the coating film Pa is fed, and after the coating film Pa has been transferred to the targeted object, the substrate P is taken up by the take-up reel 2. Table 1-9 below show the results of the experiments that were conducted to confirm the effects of the present invention.

The coating film Pa used in the experiments comprises the following ingredients:
Emulsion-type acrylic adhesive
37.0 Wt % (as solid content)
Rosin-type tackifier
4.5 Wt % (as solid content)
Phthalocyanine blue colorant
1.5 Wt %
Crawling inhibitor
2.5 Wt %
Water 54.5 Wt %

The coating film Pa comprising the above compositions was applied onto the substrate P to a thickness of 20 μm and a width of 6 mm. The substrate P was formed of polyethylene terephthalate and had a thickness of 25 μm, and it was processed to provide releasability on both surfaces thereof.

The experiments were conducted as discussed below.

1. Sticking Test:

Before using the transfer tool, the substrate P coated with the coating film Pa intentionally had slack within the housing 4 and brings the coating film in contact with the inner wall of the housing 4. Then, the slack was removed and the inner walls were checked as to whether or not the coating film Pa stuck to any inner wall of the housing 4.

In Tables 1-9, the samples were evaluated and placed in 6 categories as follows:
6: Not stuck at all.
5: Stuck slightly but negligibly.
4: Stuck slightly.
3: Stuck a little.
2: Stuck and problematic for practical use.
1: Much sticking and impracticable.

2. Injection Stability Test:

When the housing 4 of the transfer tool was injection-molded, the molding material for it was tested for its injection moldability. In Tables 1-9, the samples were evaluated in 3 categories as follows:
3: Good injection-molding with no problem.
2: Unstable to some degree but not problematic for practical use.
1: Unstable and problematic for practical use.

3. Mold Releasability Test:

When the housing 4 was injection-molded, it was tested for the mold releasability thereof. In Tables 1-9, the samples were evaluated in 3 categories as follows:
3: Released with no problem.
2: Difficult to release but not problematic for practical use.
1: Impossible to release, or even though released, the projections of the roughened surface of the product were rounded and the product was problematic for quality.

In Table 1, the sample transfer tools used in the Examples have the following characteristics: In Examples 1-14 in Tables 1-3, the roughened surface had a mat-finished crepe pattern.

Example 1: the roughed surface had a Ra of 4.7 μm and a tp of 13.1%, and was made of polystyrene without non-stick material added thereto.

Example 2: the roughed surface had a Ra of 9.2 μm and a tp of 14.7%, and was made of polystyrene without non-stick material added thereto; and the load length ratio (tp) fell within the preferred range.

Example 3: the roughed surface had a Ra of 9.8 μm and a tp of 22.0%, and was made of polystyrene without non-stick material added thereto; and the load length ratio (tp) was outside the preferred range.

Example 4: the roughed surface had a Ra of 4.8 μm and a tp of 13.2%, and was made of polypropylene without non-stick material added thereto.

Example 5: the roughed surface had a Ra of 4.7 μm and a tp of 13.2%, and was made of polystyrene with a non-stick material added thereto at 0.3%; and the amount of the non-stick material fell within the preferred range.

In Table 2, the sample transfer tools used in the Examples 6-10 have the following characteristics.

Example 6: the roughed surface had a Ra of 4.8 μm and a tp of 13.1%, and was made of polystyrene with a non-stick material added thereto at 0.8%; and the amount of the non-stick material was increased within the preferred range.

Example 7: the roughed surface had a Ra of 9.6 μm and a tp of 22.0%, and was made of polystyrene with a non-stick material added thereto at 1.0%; and the load length ratio (tp) and the amount of the non-stick material were outside the preferred range.

Example 8: the roughed surface had a Ra of 9.1 μm and a tp of 14.5%, and was made of polystyrene with a non-stick material added thereto at 0.3%; and the load length ratio (tp) and the amount of the non-stick material were within the preferred range.

Example 9: the roughed surface had a Ra of 9.1 μm and a tp of 14.6%, and was made of polypropylene without non-stick material added thereto; and the load length ratio (tp) fell within the preferred range.

Example 10: the roughed surface had a Ra of 4.6 μm and a tp of 13.1%, and was made of polystyrene with a non-stick material added thereto at 0.1%; and the amount of the non-stick material was outside the preferred range.

In Table 3, the sample transfer tools used in Examples 11-14 have the following characteristics.

Example 11: the roughed surface had a Ra of 7.1 μm and a tp of 14.7%, and was made of polystyrene without non-stick material added thereto; and the load length ratio (tp) and the center line average height Ra fell within the preferred range.

Example 12: the roughed surface had a Ra of 12.1 μm and a tp of 16.8%, and was made of polystyrene without non-stick material added thereto; and the center line average height Ra was increased from Example 11.

Example 13: the roughed surface had a Ra of 9.3 μm and a tp of 18.0%, and was made of polystyrene without non-stick material added thereto; and the load length ratio (tp) was increased within the preferred range.

Example 14: the roughed surface had a Ra of 9.1 μm and a tp of 15.0%, and was made of polypropylene with a non-stick material added thereto at 0.5%; and all parameters fell within the preferred range.

In Table 4, the sample transfer tools used in Examples 15-18 have the following characteristics. (In Examples 15-34 in Tables 4-8, the projections of the roughened surface 5 were gabled, having a triangular cross section as shown in FIG. 7A).

Example 15 the roughed surface had a tip angle of 5° and a p/h of 14, and was made of polystyrene without non-stick material added thereto; and the tip angle was at the lowermost limit with the ratio p/h of pitch p to height h falling within the preferred range.

Example 16: the roughed surface had a tip angle of 120° and a p/h of 14, and was made of polystyrene without non-stick material added thereto; and the tip angle was at the uppermost limit with the ratio p/h of pitch p to height h falling within the preferred range.

Example 17: the roughed surface had a tip angle of 3° and a p/h of 14, and was made of polystyrene without non-stick material added thereto; and the tip angle was less than the lower limit.

Example 18: the roughed surface had a tip angle of 150° and a p/h of 14, and was made of polystyrene without non-stick material added thereto; and the tip angle was above the upper limit.

In Examples 19-29 in Tables 5-7, the roughed surface was made of polystyrene without non-stick material added thereto, in which the tip angle of the projections was fixed at 60° and the ratio (p/h) of the distance between the neighboring projections, or that is, the pitch, (p), of the projections to the height, (h), of the projections was varied.

In Table 8, the sample transfer tools used in Examples 30-34 have the following characteristics.

Example 30: the roughed surface had a tip angle of 60° and a p/h of 16, and was made of polystyrene with a non-stick material added thereto at 0.1%; and the amount of the non-stick material was outside the preferred range.

Example 31: the roughed surface had a tip angle of 60° and a p/h of 16, and was made of polystyrene with a non-stick material added thereto at 0.3%; and the amount of the non-stick material was increased into the preferred range.

Example 32: the roughed surface had a tip angle of 60° and a p/h of 16, and was made of polystyrene with a non-stick material added thereto at 0.8%; and the amount of the non-stick material was increased within the preferred range.

Example 33: the roughed surface had a tip angle of 60° and a p/h of 16, and was made of polystyrene with a non-stick material added thereto at 1.0%; and the amount of the non-stick material is outside the preferred range.

Example 34: the roughed surface had a tip angle of 60° and a p/h of 14, and was made of polypropylene without non-stick material added thereto; and the material of the housing was changed.

In Table 9, the sample transfer tools used in Comparative Examples 1-4 have the following characteristics.

Comparative Example 1: the roughed surface was not formed and made of polystyrene without non-stick material added thereto.

Comparative Example 2: the roughed surface was not formed and made of polystyrene with a non-stick material added thereto at 0.8%; and the amount of the non-stick material fell within the preferred range.

Comparative Example 3: the roughed surface was not formed and made of polystyrene with a non-stick material added thereto at 2.0%; and the amount of the non-stick material was increased within the preferred range.

Comparative Example 4: the roughed surface was not formed and made of polypropylene without non-stick material added thereto; and the material of the container was changed.

In these Examples, the center line average height (Ra) and the load length ratio (tp) were measured with Rank Taylor Hobson's Talysurf 76 Model. Also in these Examples the load length ratio (tp) is at a cut level (c) of 20%. The non-stick material used is magnesium stearate, and its content is in terms of the ratio by weight to all the resins to form the housing 4.

TABLE 1

| | | | Example 1 | Example 2 | Example 3 | Example 4 | Example 5 |
|---|---|---|---|---|---|---|---|
| Housing | Constitution | roughened surface | yes | yes | yes | yes | yes |
| | | Ra (μm) | 4.7 | 9.2 | 9.8 | 4.8 | 4.7 |
| | | tp (%) | 13.1 | 14.7 | 22.0 | 13.2 | 13.2 |
| | Material | polystyrene | yes | yes | yes | — | yes |
| | | polypropylene | — | — | — | yes | — |
| | | Non-stick material | 0.0 | 0.0 | 0.0 | 0.0 | 0.3 |
| | | content (%) | | | | | |

| | | | | | | |
|---|---|---|---|---|---|---|
| Evaluation | sticking | 3 | 5 | 4 | 5 | 5 |
| | injection stability | 3 | 3 | 3 | 3 | 3 |
| | mold releasability | 3 | 3 | 3 | 3 | 3 |

TABLE 2

| | | | Example 6 | Example 7 | Example 8 | Example 9 | Example 10 |
|---|---|---|---|---|---|---|---|
| Housing | Constitution | roughened surface | yes | yes | yes | yes | yes |
| | | Ra (μm) | 4.8 | 9.6 | 9.1 | 9.1 | 4.6 |
| | | tp (%) | 13.1 | 22.0 | 14.5 | 14.6 | 13.1 |
| | Material | polystyrene | yes | yes | yes | — | yes |
| | | polypropylene | — | — | — | yes | — |
| | | Non-stick material | 0.8 | 1.0 | 0.3 | 0.0 | 0.1 |
| | | content (%) | | | | | |

| | | | | | | |
|---|---|---|---|---|---|---|
| Evaluation | sticking | 6 | 6 | 6 | 6 | 3 |
| | injection stability | 3 | 2 | 3 | 3 | 3 |
| | mold releasability | 3 | 3 | 3 | 3 | 3 |

TABLE 3

| | | | Example 11 | Example 12 | Example 13 | Example 14 |
|---|---|---|---|---|---|---|
| Housing | Constitution | roughened surface | yes | yes | yes | yes |
| | | Ra (μm) | 7.1 | 12.1 | 9.3 | 9.1 |
| | | tp (%) | 14.7 | 16.8 | 18.0 | 15.0 |
| | Material | polystyrene | yes | yes | yes | — |
| | | polypropylene | — | — | — | yes |
| | | Non-stick material | 0.0 | 0.0 | 0.0 | 0.5 |
| | | content (%) | | | | |

| | | | | | |
|---|---|---|---|---|---|
| Evaluation | sticking | 4 | 5 | 5 | 6 |
| | injection stability | 3 | 3 | 3 | 3 |
| | mold releasability | 3 | 3 | 3 | 3 |

TABLE 4

| | | | Example 15 | Example 16 | Example 17 | Example 18 |
|---|---|---|---|---|---|---|
| Housing | Constitution | roughened surface | yes | yes | yes | yes |
| | | tip angle | 5 | 120 | 3 | 150 |
| | | p/h | 14 | 14 | 14 | 14 |
| | Material | polystyrene | yes | yes | yes | yes |
| | | polypropylene | — | — | — | — |
| | | Non-stick material | 0.0 | 0.0 | 0.0 | 0.0 |
| | | content (%) | | | | |

| | | | | | |
|---|---|---|---|---|---|
| Evaluation | sticking | 6 | 3 | 6 | 2 |
| | injection stability | 3 | 3 | 3 | 3 |
| | mold releasability | 2 | 3 | 1 | 3 |

TABLE 5

| | | | Example 19 | Example 20 | Example 21 | Example 22 |
|---|---|---|---|---|---|---|
| Housing | Constitution | roughened surface | yes | yes | yes | yes |
| | | tip angle | 60 | 60 | 60 | 60 |
| | | p/h | 10 | 12 | 14 | 16 |
| | Material | polystyrene | yes | yes | yes | yes |
| | | polypropylene | — | — | — | — |
| | | Non-stick material | 0.0 | 0.0 | 0.0 | 0.0 |
| | | content (%) | | | | |

| | | | | | |
|---|---|---|---|---|---|
| Evaluation | sticking | 6 | 6 | 5 | 4 |
| | injection stability | 3 | 3 | 3 | 3 |
| | mold releasability | 3 | 3 | 3 | 3 |

TABLE 6

| | | | Example 23 | Example 24 | Example 25 | Example 26 |
|---|---|---|---|---|---|---|
| Housing | Constitution | roughened surface | yes | yes | yes | yes |
| | | tip angle | 60 | 60 | 60 | 60 |
| | | p/h | 18 | 20 | 22 | 24 |
| | Material | polystyrene | yes | yes | yes | yes |
| | | polypropylene | — | — | — | — |
| | | Non-stick material | 0.0 | 0.0 | 0.0 | 0.0 |
| | | content (%) | | | | |

| | | | | | |
|---|---|---|---|---|---|
| Evaluation | sticking | 3 | 3 | 3 | 2 |
| | injection stability | 3 | 3 | 3 | 3 |
| | mold releasability | 3 | 3 | 3 | 3 |

TABLE 7

| | | | Example 27 | Example 28 | Example 29 |
|---|---|---|---|---|---|
| Housing | Constitution | roughened surface | yes | yes | yes |
| | | tip angle | 60 | 60 | 60 |
| | | p/h | 26 | 28 | 30 |
| | Material | polystyrene | yes | yes | yes |
| | | polypropylene | — | — | — |
| | | Non-stick material | 0.0 | 0.0 | 0.0 |
| | | content (%) | | | |

| | | | | |
|---|---|---|---|---|
| Evaluation | sticking | 1 | 1 | 1 |
| | injection stability | 3 | 3 | 3 |
| | mold releasability | 3 | 3 | 3 |

TABLE 8

| | | | Example 30 | Example 31 | Example 32 | Example 33 | Example 34 |
|---|---|---|---|---|---|---|---|
| Housing | Constitution | roughened surface | yes | yes | yes | yes | yes |
| | | tip angle | 60 | 60 | 60 | 60 | 60 |
| | | p/h | 16 | 16 | 16 | 16 | 14 |
| | Material | polystyrene | yes | yes | yes | yes | — |
| | | polypropylene | — | — | — | — | yes |
| | | Non-stick material | 0.1 | 0.3 | 0.8 | 1.0 | 0.0 |
| | | content (%) | | | | | |

| | | | | | | |
|---|---|---|---|---|---|---|
| Evaluation | sticking | 4 | 5 | 6 | 6 | 6 |
| | injection stability | 3 | 3 | 3 | 2 | 3 |
| | mold releasability | 3 | 3 | 3 | 3 | 3 |

TABLE 9

| | | | Comparative | Comparative | Comparative | Comparative |
|---|---|---|---|---|---|---|
| | | | Example 1 | Example 2 | Example 3 | Example 4 |
| Housing | Constitution | roughened surface | no | no | no | no |
| | | Ra (μm) | — | — | — | — |
| | | tp (%) | — | — | — | — |
| | | tip angle | — | — | — | — |
| | | p/h | — | — | — | — |
| | Material | polystyrene | yes | yes | yes | — |
| | | polypropylene | — | — | — | yes |
| | | Non-stick material | 0.0 | 0.8 | 2.0 | 0.0 |
| | | content (%) | | | | |

| | | | | | |
|---|---|---|---|---|---|
| Evaluation | sticking | 1 | 1 | 2 | 1 |
| | injection stability | 3 | 2 | 1 | 3 |
| | mold releasability | 3 | 3 | 3 | 3 |

The test results confirm the following:

Since the housings in Examples 1 to 34 had a roughened surface, the coating film was prevented from sticking to the inner walls of the housings as compared with those in Comparative Examples 1 to 4. Regarding the injection stability in molding the container bodies, when the amount of the lubricant added to the molding materials was large, some problems occurred but were negligible.

In Example 1, the housing had the roughened surface and the coating film was prevented from sticking to it, as compared with Comparative Examples 1 to 4. In addition, the housing was stably injection-molded.

In Example 2, the center line average height, (Ra) was larger than 5.0 μm. Accordingly, the roughened surface prevented the coating film from sticking and the effect was better than that demonstrated in Example 1. Also, the housing had a stable injection-mold.

In Example 3, the center line average height, (Ra) was larger than 5.0 μm, but the load length ratio (tp) was greater than 20%. When compared with Example 2, the sticking resistance was not as good, but it was better than that in Comparative Examples 1 to 4 and Example 1. In addition, the housing demonstrated a stable injection-mold.

In Example 4, the center line average height, (Ra) of the roughened surface was lower than 5.0 μm. However, since polypropylene, which exhibits good releasability, was used, the sticking resistance was better than that in Example 1. In addition, the housing demonstrated a stable injection-mold.

In Example 5, the center line average height, (Ra) of the roughened surface was lower than 5.0 μm. However, since a non-stick material (magnesium stearate) was added to the molding material for the housing, the sticking resistance was better than that in Example 1. In addition, the housing demonstrated a stable injection-mold.

In Example 6, the center line average height, (Ra) of the roughened surface was lower than 5.0 μm. However, since the amount of a non-stick material (magnesium stearate) added to the molding material was larger than that in Example 5, the sticking resistance was better than in Example 5.

In Example 7, the center line average height, (Ra) of the roughened surface was larger than 5.0 μm and a non-stick material (magnesium stearate) was added to the molding material. Therefore, the coating film did not stick to the housing at all even though the coating film was brought in contact with the inner wall. However, the injection stability was lower in some degree since the amount of the non-stick material added to the molding material was large.

Example 8 differs from Example 7 in that the load length ratio (tp) and the amount of the non-stick material were both within the preferred range. As was the case in Example 7, the product did not stick at all to the housing. In addition, the injection stability was better than in Example 7.

In Example 9, no non-stick material was added to the molding material. However, the center line average height, (Ra) of the roughened surface is larger than 5.0 μm, the load length ratio (tp) was within the preferred range, and polypropylene which exhibits good releasability was used. Therefore, the sticking resistance was comparable to Example 8, and the injection stability was also good.

In Example 10, the housing had a roughened surface and contained a non-stick material. However, since the amount of the lubricant was lower than the preferred range, the sticking resistance was on the same level as in Example 1. The injection stability was good.

In Example 11, the center line average height, (Ra) was larger than 5.0 μm and the load length ratio (tp) was within the preferred range. Therefore, the coating film was prevented from sticking to the housing, as compared with Comparative Examples 1 to 4. In addition, since the center line average height, (Ra) fell between 7 μm and 9 μm, the medium sticking resistance was better than that in Example 1 but not Example 2.

In Example 12, the center line average height, (Ra) was larger than 12.0 μm. When the center line average height, (Ra) is at least 9.0 μm, the coating film can be prevented from reaching the depth of the recesses of the roughened surface. Therefore compared with Example 2 in which the center line average height (Ra) was about 9.0 μm, the sticking resistance in this Example was not as enhanced.

Example 13 differs from Example 2 in that the load length ratio (tp) was 18.0% and was increased within the preferred range. This gave the same result as Example 2.

Example 14 satisfied all the limitations in claims 1, 2 and 5, like Example 8, and there was no problem observed.

In Example 15, the tip angle of the projections of the roughened surface was at the lower most limit of the preferred range and the ratio (p/h) of pitch (p) to height (h) of the projections was lower than 22.0. Therefore, as compared with Comparative Examples 1 to 4, the sticking resistance was good and the injection stability was also good. Additionally, the housing formed was well released from the mold with no problem.

In Example 16, the tip angle of the projections of the roughened surface was at the uppermost limit of the preferred range and the ratio (p/h) of pitch (p) to height (h) of the projections was lower than 22.0. Therefore, as compared with Example 15, the housing formed was readily released from the mold.

In Example 17, since the ratio (p/h) of pitch (p) to height (h) of the projections was lower than 22.0, the sticking resistance was ensured. In this, however, since the tip angle of the projections of the roughened surface was smaller than the lowermost limit of the preferred range, the tips of the projections were damaged when the housing was released from the body, when compared with those in Example 15.

In Example 18, though the ratio (p/h) of pitch (p) to height (h) of the projections was lower than 22.0, the tip angle of the projections of the roughened surface was larger than the uppermost limit of the preferred range. In this Example, the sticking resistance was not as good though the mold releasability was better than that in Example 15.

Examples 19 to 29 essentially correspond to claims 1, 3 and 4, in which the tip angle of the projections was fixed to 60° and only the ratio (p/h) of pitch (p) to height (h) of the projections was varied to investigate the sticking resistance. The test results confirmed the following: The ratio (p/h) of pitch (p) to height (h) of the projections is preferably at most 22.0 (Examples 19 to 25), a more preferable value is 16.0 (Examples 19 to 22), and the most preferable value is 12.0 (Examples 19 and 20). In these preferred Examples, the sticking resistance was better than that demonstrated in Examples 26 to 29 where the ratio was higher than 22.0.

Example 30 differs from Example 22 in that it contained a non-stick material (magnesium stearate) but the amount thereof was lower than the preferred range. There was no difference in the sticking resistance between these Examples.

Example 31 differs from Example 30 in that the amount of the non-stick material (magnesium stearate) was increased within the preferred range. Accordingly, the sticking resistance was better as compared with that in Example 30, and the injection stability and the mold releasability were both good.

Example 32 differs from Example 31 in that the amount of the non-stick material (magnesium stearate) was further increased within the preferred range. Accordingly, the sticking problem was solved completely, and the results were all good.

Example 33 differs from Example 32 in that the amount of the non-stick material (magnesium stearate) was further increased over the preferred range. In this, the coating film did not stick at all but the injection stability was not good when compared with Example 32.

Example 34 differs from Example 21 in that a non-stick material (polypropylene) was used for the housing, in which the medium sticking resistance was enhanced beyond Example 21.

In Comparative Example 1, the inner walls of the housing were not roughened and therefore the coating film stuck. However, the injection stability was good.

In Comparative Example 2, the inner walls of the housing were not roughened, but a non-stick material (magnesium stearate) was added to the molding material. As compared with Comparative Example 1, the sticking resistance improved to some degree but was still at a low level. In addition, the injection stability was not good.

In Comparative Example 3, the inner walls of the housing were not roughened, but a non-stick material (magnesium stearate) was added to the molding material and the amount was larger than that in Comparative Example 2. The sticking resistance was better to some degree than in Comparative Example 2, but was still worse than the other Examples where the inner walls of the housing were roughened. In addition, the injection stability was much worse than that in Comparative Example 2.

In Comparative Example 4, the inner walls of the housing were not roughened, but polypropylene was used for the molding material. However, the change did not improve the sticking resistance at all. Since no non-stick material was added to the molding material, the injection moldability was at the same level as in Comparative Example 1.

As described in detail above with reference to the preferred embodiments, the invention has made it possible to prevent a coating film on a ribbon-like substrate from sticking to the inner walls of a housing in a transfer tool, enuring good injection stability and good mold releasability in the injection-molding for the housing.

Although the examples are shown in which the coating film Pa is an adhesive film, the same results can be expected even if the coating film Pa is a correction film. In the Examples illustrated above, the profile of the roughened surface 5 is not limited to that of FIG. 2. It should be noted that the profile of the roughened surface 5 may also be any others such as those in FIG. 7. In addition, it may also be like grains, woven fabric, leather, or repetitions of a predetermined pattern. Polystyrene and polypropylene are used in the Examples for the material of the housing 4, and magnesium stearate is added to it as a non-stick material. However, these are not limitative. The material of the housing 4 may be ABS or polycarbonate, and the non-stick material may also be any of zinc stearate, aluminum stearate or calcium stearate.

It is therefore intended that the foregoing detailed description be regarded as illustrative rather than limiting, and that it be understood that it is the following claims, including all equivalents, that are intended to define the spirit and scope of this invention.

1. A transfer tool comprising:
a housing having an interior surface; and
a ribbon substrate that travels inside the housing, the ribbon substrate being coated with a coating film to be transferred from the substrate, wherein the interior surface of the housing is roughened at least in a region where the coating film on the ribbon substrate may contact the interior surface of the housing.

2. A transfer tool as recited in claim 1, wherein the ribbon substrate is a tape.

3. A transfer tool as recited in claim 1, wherein at least the roughened surface of the housing contains a non-stick material.

4. A transfer tool as recited in claim 1, wherein the roughened surface is formed of multiple projections.

5. A transfer tool as recited in claim 4, wherein the center line average height of the multiple projections is at least 5.0 μm.

6. A transfer tool as recited in claim 4, wherein a ratio of a pitch to a height of the multiple projections of the roughened surface is at most 22.0.

7. A transfer tool as recited in claim 4, wherein a tapered angle of a tip of each projection of the roughened surface falls between 5° and 120°.

8. A transfer tool as recited in claim 4, wherein a cut level of the multiple projections is equal to or less than 20%.

9. A transfer tool as recited in claim 5, wherein a load length ratio at a cut level of 20% is equal to or less than 20%.

10. A transfer tool as recited in claim 1, wherein the entire inner surface of the housing has a roughened surface.

11. A transfer tool as recited in claim 1, wherein the housing has a roughened surface along a path where the substrate travels inside the housing.

12. A transfer tool as recited in claim 10, further comprising a dispenser at which the coating film is dispensed from the substrate, wherein the roughed surface is provided at least on an upstream side of the dispenser.

13. A transfer tool as recited in claim 1, wherein the housing and the roughened inner surfaces are formed integrally in an injection-molding process.

14. A transfer tool as recited in claim 1, wherein the housing and the roughened inner surface are formed of a material comprising a non-stick material in an amount of 0.3 to 0.8% of material weight.

15. A transfer tool as recited in claim 13 wherein the non-stick material is selected from a group comprising magnesium stearate, zinc stearate, aluminum stearate and calcium stearate.

16. A transfer tool as recited in claim 4, wherein the projections are formed in a pattern selected from a group consisting of a creping pattern, a grain pattern, a woven fabric pattern, a leather pattern, a repetition of predetermined pattern and a mat-finished pattern.

17. A transfer tool as recited in claim 1, wherein the coating film is a correction film.

18. A transfer tool as recited in claim 1, wherein the coating film is an adhesive film.

19. A transfer tool as recited in claim 1, wherein the substrate is formed mainly of polyethylene terephthalate and has a thickness of about 25 μm.

20. A transfer tool as recited in claim 1, wherein the substrate is processed for both surfaces to exhibit releasability.

21. A transfer tool as recited in claim 18, wherein the coating film comprising emulsion-type acrylic adhesive, rosin-type tackifier, phthalocyanine blue colorant, crawling inhibitor and water.

22. A transfer tool as recited in claim 18, wherein the coating film is about 20 μm in thickness.
